(19) United States
(12) Patent Application Publication
(10) Pub. No.: US 2003/0141254 A1
(43) Pub. Date: Jul. 31, 2003

(54) Process for treating waste water to remove contaminants

(76) Inventor: Timothy L. Stewart, Cartersville, GA (US)

Correspondence Address: Thomas A. Hodge, Baker, Donelson, Bearman & Caldwell, Suite 900, Five Concourse Parkway, Atlanta, GA, 30328, US

(21) Appl. No.: 10/200,047

(22) Filed: Jul. 18, 2002

Related U.S. Application Data
(60) Provisional application No. 60/353,220, filed on Jan. 31, 2002.

(51) Int. Cl. C02F 1/24

(52) U.S. Cl. 210/705

(57) ABSTRACT

Waste water is treated to remove contaminants and produce a sludge cake with a high percentage of solids and a treated waste water that can be discharged into a municipal sewer system.

This application claims the benefit of U.S. Provisional Application Serial No. 60/353,220, filed Jan. 31, 2002.

### TECHNICAL FIELD

The present invention relates to a process for treating waste water. In a more specific aspect, this invention relates to a process for treating waste water to remove contaminants from the waste water.

As used in this application, the term “contaminants” generally refers to the materials which must either be removed from waste water or at least removed in a sufficient quantity to meet effluent discharge requirements, before the treated waste water (i.e., the effluent) can be discharged into a municipal or other sewer system. Examples of such materials are human waste, oil, grease, biochemical oxygen, grit, sand, etc.

### BACKGROUND OF THE INVENTION

Most cities and counties have enacted requirements for industries which discharge water into municipal sewer systems. These municipalities generally require the waste water to meet certain requirements before being discharged into the sewer systems, and these requirements usually relate to the level of contaminants which interfere with the efficient operation of the municipal waste water treatment facility.

Waste water which contains materials having a high biological oxygen demand, total suspended solids and ammonia increase the treatment cost to the city or county. For purposes of this invention, the term “biological oxygen demand” (“BOD”) refers to the quantity of oxygen utilized in biochemical oxidation of organic matter; and the term “total suspended solids” (“TSS”) refers to the total suspended solids which float on the surface of, or are suspended in, waste water and which are removable by filtering.

In some instances, a surcharge may be levied on an industrial plant that produces waste water which does not meet the standards as established by the municipality.

A city or county also has the authority to revoke an industrial plant's waste water discharge permit if that plant continues to discharge waste water which does not meet the requirements set by that city or county. Therefore, an industrial plant must effectively treat its waste water to reduce the level of contaminants to comply with such requirements.

An effective waste water treatment process should cause the solid organic and inorganic matter in the waste water to flocculate and form a sludge cake. This sludge cake accumulates to a certain thickness and is then separated from the liquid component of the waste water and typically sent either for disposal or to a rendering plant for further processing.

A common method of treating waste water is the dissolved air flotation method (“DAF”) which injects dissolved air into the waste water, causing the solids to rise to the top. However, the DAF method tends to produce a sludge cake with a low percentage of solids.

Another method of treating waste water is to use a clarifying or settling tank with a filter at the bottom. The waste water is chemically treated within the tank, and the solids sink to the bottom of the tank. The liquid component of the waste water is directed out of the tank, and a wet cake is left on the filter. This method produces a sludge cake with typically low solids.

With the DAF method or the settling tank method, a belt press can be used to produce a sludge cake with a higher solids content. However, this step requires additional equipment and expense.

Another method of treating waste water from an industrial plant is disclosed in Stewart U.S. Pat. No. 4,981,599 (1991). This process results in the formation of a sludge cake on top of the waste water. The sludge cake is removed, and the treated waste water is discharged into the sewer system.

However, the sludge cake (also referred to as the float material) produced by the prior treatment processes is not ideally suited for subsequent treatment at a rendering plant because (1) the water content of the float material is higher than desired and (2) the float material is comprised of fatty and protein components which desirably should be separated from the water component.

Therefore, there is a need for a process that effectively treats (a) industrial waste water to meet the requirements as set by a city or county so that such waste water can be discharged into a municipal sewer system and (b) produces a sludge cake with a high percentage of solids.

### SUMMARY OF THE INVENTION

The present invention provides a process for treating waste water to produce a drier sludge cake (i.e., a sludge cake with a high percentage of solids) and waste water that can be discharged into a municipal sewer system prior to further treatment in a municipal waste water treatment facility.

Although the present invention is believed to have utility for treating all types of waste water, the present invention is especially useful in treating industrial waste water from a food processing plant.

Briefly described, the present invention treats waste water with a pH adjusting material, a flocculating agent and injected air bubbles and then directs the waste water to a dissolved air flotation unit. During residence in the DAF unit, a sludge cake is formed and removed, a first portion of the treated waste water is discharged into a municipal sewer system and a second portion of the treated waste water is recycled through the process.

Accordingly, an object of this invention is to provide a process for treating waste water.

Another object of this invention is to provide a process for treating waste water before being discharged into a municipal sewer system.

Another object of this invention is to provide a process for removing contaminants from waste water.

Another object of this invention is to provide a process for treating waste water to meet applicable requirements set by municipality for a municipal sewer system.

Still another object of this invention is to provide a process for treating waste water to cause the flocculation of contaminants in the waste water to form a sludge cake which can then be removed.

Still another object of this invention is to provide a process for treating waste water to produce a sludge cake having a high percentage of solids.

Still another object of this invention is to provide a process for treating waste water in which a portion of the treated waste water is recycled through the process.

These and other objects, features and advantages of this invention will become apparent from the following description.

### DETAILED DESCRIPTION OF THE INVENTION

The present invention provides a process for treating waste water to remove contaminants from the waste water, wherein the process comprises: treating waste water with a material to adjust the pH of the waste water; flocculating the contaminants in the waste water by adding a flocculating agent to the treated waste water; injecting air bubbles into the waste water whereby the air bubbles attach to the flocculated contaminants; moving the treated waste water to a chamber in which the flocculated contaminants rise to an upper area of the chamber; removing the flocculated contaminants from the upper area of the chamber; removing a first portion of the treated waste water from a lower portion of the chamber for discharge into a municipal system; and recycling a second portion of the treated waste water through the process.

An essential step in the process of this invention is the recycling of a portion (sometimes referred to as the “second” portion) of the treated waste water. Recycling provides enhanced results as compared to a process in which treated waste water is not recycled. In the process of this invention, recycling of a portion of the treated waste water can be accomplished through the use of high or low pressure pumps or by the use of gravity flow from the chamber.

This invention contemplates the use of various materials (sometimes referred to as “primary coagulants”) to adjust the pH of the waste water to a range of generally about 2.5 to about 10.0. The specific pH will depend upon the waste water being treated.

As used in this application, the term “chamber” generally refers to a type of container, vessel or tank in which the flocculated contaminants are separated and rise to an upper area of the chamber.

When the identity (or source) and pH of the waste water are determined, the process operator is able to select the desired pH for that waste water to be treated according to the process of this invention. The pH of the waste water may need to be raised or lowered. (For example, the pH generally needs to be raised if the waste water contains metals, but the pH generally needs to be lowered if the waste water is from a food processing plant.) A principal objective of the pH adjusting step is to bring the waste water to a pH which is within the range at which the flocculating agent (described below) is most effective in this type of process.

The pH adjusting material is preferably added to the waste water at a point in this process which ensures adequate mixing before the flocculating agent is added.

Examples of materials useful in this invention to adjust pH are hydroxide compounds such as sodium hydroxide, potassium hydroxide and calcium hydroxide; metal-containing compounds such as ferric chloride, ferric sulfate, aluminum chloride and aluminum sulfate; acidic compounds such as sulfuric acid, nitric acid and hydrochloric acid; and polymeric compounds such as polyacrylamides and polyamines. A combination of 2 or more of these materials can be used. This process does not require a specific amount of the pH adjusting material, because the amount introduced is dependent on the pH of the waste water. The pH adjusting material also combines with the solid waste matter and thereby enhances the flocculation described below.

As stated above, an iron-containing compound may be used as a pH adjusting material in the process of this invention. If an iron-containing compound is used, a hydroxide may be introduced into the waste water after the iron-containing compound but before the addition of the flocculating agent. The hydroxide may be added to adjust the pH of the waste water to correspond to the range at which the flocculating agent is most effective. The pH of the waste water may be monitored before the introduction of the flocculating agent. If the pH is within the effective range of the flocculating agent, the addition of a large amount of hydroxide is not necessary. The preferred hydroxides are sodium, potassium and calcium hydroxides, with sodium hydroxide being especially preferred.

In the situation where an iron-containing compound is used as the pH adjusting material, the addition of a hydroxide will also buffer the waste water to ensure that sufficient iron has entered the waste water for further processing according to this invention.

The flocculating agent is used to bind inorganic and organic mater in the waste water, thereby producing a removable sludge cake with a high percentage of solids (i.e., about 20%-50%, and preferably at least about 30%). Although various flocculating agents may be used, preferred agents for this invention are cationic and anionic polymers, and especially preferred agents are the polyacrylamides.

The waste water being treated by this invention is generally in constant motion, as this invention is most effective in a continuous waste water treatment process.

For the process of this invention to be most effective in removing contaminants, the chamber (in which separation of the flocculated contaminants occurs) is preferably at least substantially filled with waste water at all times.

Preferably, at the start-up of the process of this invention, the initial incoming raw (i.e., untreated) waste water is first cycled or directed to the chamber, and a portion of this waste water is then recycled for treatment according to this process. Except for the initial incoming raw waste water, the incoming raw waste water must be treated, prior to being moved or directed to the chamber, by being mixed with recycled waste water which has been treated according to this invention.

Preferably in the process of this invention, the pH adjusting material, flocculating agent and injected air bubbles are mixed with the recycled waste water prior to the time at which the recycled water enters the chamber. These mixing steps can occur in various ways, such as in a series of tubes, lines or other containers. These tubes or lines are sometimes referred to in the industry as “flocc tubes” or “flocc lines”.

In this invention, the pH adjusting material, flocculating agent and injected air bubbles, respectively, are preferably added to the waste water in sequence. However, other sequences can also be effectively used in the process of this invention.

In another embodiment of this invention, sulfuric acid is used as the pH adjusting material to lower the pH of the waste water to a point at which red blood cells start to precipitate, a flocculating agent is then added and the waste water is then treated with injected air bubbles before being moved to the chamber. Again, a portion of the treated waste water is recycled through the process. This embodiment is sometimes referred as acidulation.

This invention has been described in detail with particular reference to certain embodiments, but variations and modifications can be made without departing from the spirit and scope of the invention as defined in the following claims.

What is claimed is:

1. A process for treating waste water to remove contaminants from the waste water, wherein the process comprises:
A. treating waste water with a material to adjust the pH of the waste water;
B. flocculating the contaminants by adding a flocculating agent to the waste water;
C. injecting air bubbles into the waste water whereby the air bubbles attach to the flocculated contaminants;
D. moving the treated waste water to a chamber in which the flocculated contaminants rise to an upper area of the chamber;
E. removing the flocculated contaminants from the upper area of the chamber;
F. removing a first portion of the treated waste water from a lower portion of the chamber; and
G. recycling a second portion of the treated waste water through the process.

2. A process as defined by claim 1 wherein the pH adjusting material is a hydroxide, a metal-containing compound, an acidic compound, a polymeric compound or a mixture of such compounds.

3. A process as defined by claim 2 wherein the pH adjusting material is ferric chloride, ferric sulfate, aluminum chloride, aluminum sulfate or a mixture of such materials.

4. A process as defined by claim 2 wherein the pH adjusting material is sulfuric acid, hydrochloric acid, nitric acid or a mixture of such materials.

5. A process as defined by claim 2 wherein the pH adjusting material is sodium hydroxide, potassium hydroxide, calcium hydroxide or a mixture of such materials.

6. A process as defined by claim 2 wherein the pH adjusting material is a polyacrylamide, a polyamine or a mixture of such materials.

7. A process as defined by claim 1 wherein the flocculating agent is a polymer.

8. A process as defined by claim 7 wherein the flocculating agent is a cationic polymer, an anionic polymer or a mixture of such polymers.

9. A process as defined by claim 7 wherein the flocculating agent is a polyacrylamide.

10. A process as defined by claim 7 wherein the flocculating agent is a polyamine.
